(19) United States
(12) Patent Application Publication
(10) Pub. No.: US 2023/0359488 A1
(43) Pub. Date: Nov. 9, 2023

(54) CENTRAL PROCESSING UNIT WITH MULTIPLE INSTRUCTION QUEUES

(71) Applicant: UNIVERSITEIT GENT, Gent (BE)

(72) Inventors: Lieven EECKHOUT, Evergem (BE); Kartik LAKSHMINARASIMHAN, Gent (BE); Ajeya NAITHANI, Gent (BE)

(21) Appl. No.: 18/029,232

(22) PCT Filed: Sep. 24, 2021
(86) PCT No.: PCT/EP2021/076396

§ 371 Date: Mar. 29, 2023

(30) Foreign Application Priority Data
Oct. 1, 2020 (EP) 20199592.5

(51) Int. Cl. G06F 9/48; G06F 9/30

(52) U.S. Cl. CPC G06F 9/4881; G06F 9/30043; G06F 9/30123

(57) ABSTRACT

A central processing unit (CPU) includes a plurality of physical registers and instruction queues; a respective queue respectively configured to buffer instructions for execution; the instructions referencing one or more of the physical registers. The CPU includes a dispatching circuitry configured to: i) when a respective instruction is an independent load instruction, which is a load instruction to load data from an addressable memory into a physical register, and is independent from instructions buffered in the instruction queues through the physical registers, then dispatch the respective instruction to a first queue of the instruction queues; and ii) when the respective instruction is a dependent instruction dependent on the independent load instruction, then dispatch the respective instruction to another queue of the instruction queues.

### TECHNICAL FIELD

Various example embodiments relate to a central processing unit, CPU, having a plurality of physical registers and instruction queues.

### BACKGROUND

A central processing unit, also referred to as a processor, is a circuitry that executes instructions that make up a computer program. These instructions are formatted according to the CPU's instruction set architecture, ISA.

Different types of CPU designs allow trading off between different system requirements such as speed, power consumption, area, latency, and design complexity. One type of CPU designs are so-called in-order, InO, processors that execute the instructions in a strict sequential manner. InO processors typically have a simple design, a small area and low power consumption at the expense of lower performance. At the other end of the spectrum are the so-called out-of-order, OoO, processors, wherein the program instructions are executed according to the availability of input data and execution units rather than the order defined by the computer program. As a result, OoO processors can deliver higher performance compared to InO processors at the expense of a higher design complexity and thus larger area and power consumption.

As an in-between solution, the slice-out-of-order, sOoO, CPU design has been proposed in T. E. Carlson et al, “The load slice core microarchitecture”, Proceedings of the 42^{nd} International Symposium on Computer Architecture (ISCA), pages 117-128, 2015, and in R. Kumar et al, “Freeway: Maximizing MLP for slice-out-of-order execution”, Proceedings of the 25^{th} International Symposium on High-Performance Computer Architecture (HPCA), pages 558-569, 2019. Such an sOoO processor addresses the issues of an in-order processor by identifying load and store instructions together with the address-generating sequence of instructions that lead to these load and store instructions, also referred to as the backward slice. Such backward slice is then dispatched onto a first instruction queue and other instructions onto another instruction queue. Instructions from different queues are then allowed to execute out-of-order. An sOoO processor relies on two circuitries for identifying these backward slices in an iterative manner by an iterative backward dependence analysis: the register dependence table, RDT, and the instruction slice table, IST.

Apart from the added hardware overhead incurred by the RDT and IST, the iterative backward dependence analysis in itself is imperfect. First, when the code footprint is too big to fit within the IST, instructions are removed from the IST which results in suboptimal dispatching to the queues. Second, iteratively constructing backward slices leads to instructions that are dispatched before the backward slice is complete, again resulting in suboptimal dispatching.

### SUMMARY

The scope of protection sought for various embodiments of the invention is set out by the independent claims.

The embodiments and features described in this specification that do not fall within the scope of the independent claims, if any, are to be interpreted as examples useful for understanding various embodiments of the invention.

Amongst others, it is an object of the present disclosure to alleviate the above identified problems and thereby provide an improved processor design.

This object is achieved, according to a first example aspect of the present disclosure, by a central processing unit, CPU comprising a plurality of physical registers and instruction queues respectively configured to buffer instructions for execution; the instructions referencing one or more of the physical registers; the CPU further comprises a dispatching circuitry configured to:
when a respective instruction is an independent load instruction, wherein the independent load instruction is a load instruction to load data from an addressable memory into a physical register, and is independent from instructions buffered in the instruction queues through the physical registers, then dispatch the respective instruction to a first queue of the queues; and
when the respective instruction is a dependent instruction dependent on the independent load instruction through the physical registers, then dispatch the respective instruction to another queue of the instruction queues.

In other words, the CPU has at least two queues for buffering instructions for later execution, i.e. the first queue and then one or more other queues. Instructions that reside in different queues can be executed out-of-order with respect to each other. Two conditions are defined for dispatching an instruction to one of the queues. The first condition checks whether the instruction is a load instruction and whether the instruction is independent from instructions that are already buffered in the instruction queues, i.e. whether the load instruction is independent from an instruction that is ahead or forward with respect to the load instruction through one or more of its physical registers. If this is the case, the instruction is sent or dispatched into a first queue for later execution. The second condition checks whether an instruction is dependent on such a type of independent load instruction, i.e. whether the instruction directly or indirectly depends on a physical register value that will be written by such an independent load instruction. If so, such an instruction is dispatched onto another queue, i.e. a queue different from the first queue. Again, this second condition is checked based on instructions that are already buffered, i.e. ahead or forward with respect to the dependent instruction.

The independent load instructions that reside in the first queue will be independent from older load instructions and, hence, will execute soon. The instructions in the other queues can then be executed when their dependencies are resolved. Because of this, the first queue is rarely stalled because of dependencies and the CPU can quickly execute the instructions buffered in the first queue. As a result, the CPU provides similar advantages as a sOoO processor over an in-order processor. Further, the dispatching is based on dependencies on instructions that are ahead in the instruction queues. As a result, the dispatching can be performed in a single step because no iterative backward dependency analysis is needed. It is therefore an advantage that complex hardware for performing such backward dependency analysis can be avoided. Further, suboptimal dispatching as occurring in sOoO processors is avoided resulting in a more stable and predictable performance.

The other instructions that do not comply with the above conditions are preferably also dispatched to the first queue.

According to example embodiments, the dispatching circuitry is further configured to, when the dependent instruction is a load instruction, dispatch the dependent instruction to a second queue of the instruction queues, and otherwise, dispatch the dependent instruction to a third queue of the instruction queues.

In other words, the dependent instructions are dispatched to different queues depending on whether they are a load instruction or not. This way, load instructions that may take a lot of cycles to execute are separated from the other instructions that will typically execute much faster. This results in a further speed increase because this way potentially blocking load instructions are separated from other instructions that may already be ready for execution.

According to further example embodiments, the instruction queues comprise a fourth queue. The CPU then comprises a redirecting circuitry configured to redirect a head instruction from the head of the third queue to the fourth queue when the head instruction has not been executed within a time threshold.

This way, the third queue is freed to serve other queued instructions that may be executed faster. As a result, at the expense of another queue and limited hardware circuitry, the overall performance of the CPU is further increased.

The CPU may further comprise a counter, e.g. a down counting timer, that is configured to count a certain amount of cycles, to trigger the redirecting of the head instruction upon reaching the certain amount of cycles and thereupon to reset.

Exceeding such a time threshold may indicate that a load instruction encountered a memory cache miss causing it to stall for a large amount of cycles. The time threshold may be specifically selected to indicate a certain cache miss, e.g. an L1, L2 or L3 memory cache miss.

According to embodiments, the CPU further comprises a selection circuitry configured to pop an instruction from one of the instruction queues for further execution. Such popping may for example be performed according to a selection policy.

In other words, the selection circuitry takes a selected instruction from one of the queues and sends it for execution to a functional unit that is configured to execute the type of selected instruction.

According to embodiments, the dispatching circuitry is further configured to: when the respective instruction is a store-address instruction, and when the store-address instruction computes a target address in the addressable memory for later storage by a store-data instruction; then replicate the instruction onto all other instruction queues; and the selection circuitry is further configured to pop the store-address instruction from all the queues when it is at the head of all the queues.

A specific store-address instruction is thus dispatched onto all queues and will thus also traverse all queues. The selection circuitry will then refrain from taking the instruction for execution until this instruction is ready for execution in all the instruction queues.

In the CPU, a load instruction may be selected from the first queue or the second queue when applicable. A store instruction may further be selected from the first queue, the third queue or fourth queue when applicable. A load instruction may therefore bypass an older store instruction. While executing a load instruction ahead of an earlier store instruction may improve performance, through-memory dependencies have to be respected at all times. In particular, a load instruction that executes before an older store instruction may possibly read an old value if the load and store instructions reference the same overlapping data values in memory. Correctly handling memory dependencies while executing load and store instructions in an out of program order requires complex memory disambiguation logic. By the above replication, such memory disambiguation problem is overcome in a simple manner because it guarantees that younger load instructions after the store address instruction are executed in program order.

According to embodiments, the dispatching circuitry is further configured to:
when the respective instruction is an independent load instruction, mark at least one destination physical register referenced to by the independent load instruction,
when the respective instruction reads a marked physical register, then mark one or more destination physical registers of the respective instruction;
   and wherein the CPU is configured to, when executing or selecting the respective instruction, unmark one or more of the marked physical registers.

By marking the physical registers, the instructions that are soon to be dispatched can be tracked with respect to the already dispatched instructions that are still buffered in one of the queues. Further, marking or unmarking of physical registers is a simple operation and neither requires complex circuitry nor iterative operations.

According to embodiments, the dispatching circuitry is further configured to stall when a queue targeted for dispatching is full. When instructions from such queue are selected for execution, then the dispatching circuitry will resume operation.

According to embodiments, the instruction queues are in-order instruction queues, i.e. instructions are selected from the instruction queue in the same order as they were dispatched to the queue. Such in-order instruction queues have the advantage that no further queue management is needed. Alternatively, one or more of the queues may be out-of-order queues, i.e. instructions may be selected from the instruction queue in another order than they were dispatched to the queue. In such case, further stalls within a queue may be overcome at the cost of extra complexity for managing the out-of-order execution.

According to embodiments, the CPU further comprises a register renaming circuitry configured to obtain instructions referencing one or more architectural registers, and to rename the referenced architectural registers to one or more of the physical registers.

By such register renaming, false data dependencies between architectural registers that are reused by successive instructions can be eliminated. Such elimination reveals more instruction-level parallelism among the instructions, which will reduce the amount of detected dependencies by the dispatching circuitry and result in a better performance of the CPU.

According to a second aspect, embodiments relate to a method comprising:
obtaining instructions for execution on a CPU; the instructions referencing one or more physical registers in the CPU;
dispatching a respective instruction to a first queue of instruction queues in the CPU when the respective instruction is an independent load instruction; wherein the independent load instruction is a load instruction to load data from an addressable memory into a physical register, and is independent from instructions buffered in the instruction queues through the physical registers; and wherein the instruction queues are respectively configured to buffer the instructions for execution; and
dispatching the respective instruction to another queue of the instruction queues when the respective instruction is a dependent instruction depending on the independent load instruction.

### BRIEF DESCRIPTION OF THE DRAWINGS

Some example embodiments will now be described with reference to the accompanying drawings.

FIG. 1 shows an example embodiment of a central processing unit, CPU;

FIG. 2 shows steps performed by a dispatching circuitry in a CPU according to an example embodiment;

FIG. 3 shows steps performed by a selection circuitry in a CPU according to an example embodiment;

FIG. 4 shows physical registers and interaction of these registers with different circuitries in a CPU according to an example embodiment;

FIG. 5 shows further steps performed by a dispatching circuitry in a CPU according to an example embodiment;

FIG. 6 shows further steps performed by a selection circuitry in a CPU according to an example embodiment; and

FIG. 7 shows an example program code and instructions of the program code within instruction queues of a CPU according to an example embodiment.

### DETAILED DESCRIPTION OF EMBODIMENT(S)

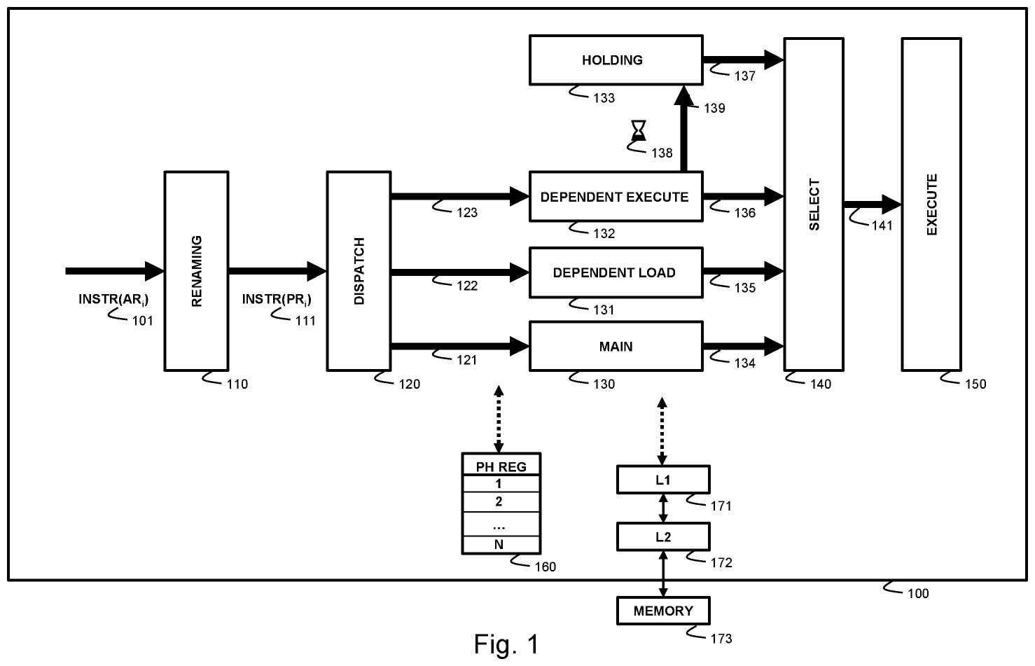

FIG. 1 shows a processor or central processing unit, CPU, 100 having different circuitries according to an example embodiment. A CPU 100, as known in the art, is a circuitry that executes instructions 101 that make up a computer program. These instructions 101 are formatted according to the CPU's instruction set architecture, ISA. The CPU design 100 is not restricted to a specific type of ISA but may be used as a microarchitecture template for different ISAs. To this end, instructions 101 may comprise data handling and memory instructions such as an instruction to set one or more registers to a constant value, a load instruction to load data from a memory location to one or more registers, and a store instructions to store one or more register values to a memory location. Instructions 101 may also comprise arithmetic operations, logic operations, and control operations.

CPU 100 may comprise a register renaming circuitry 110 that renames architectural registers referenced by the instructions 101 to physical registers 160 within the CPU 100. Such register renaming is a technique known in the art, wherein there are more registers physically available in the CPU 100 than the registers defined by the ISA, also referred to as architectural registers. By register renaming, false data dependencies between architectural registers that are reused by successive instructions can be eliminated. Such elimination then allows to execute more instructions in parallel and thus reveals more instruction-level parallelism among the instructions 101. The result of renaming circuitry are instructions 111 referencing to the actual N physical registers 160 within the CPU 100.

Instructions 111 are then provided to dispatching circuitry 120 that is configured to dispatch the instructions 111 onto one or more of the instruction queues 130, 131, 132 further referred to as the main queue 130, the dependent load queue 131 and the dependent execution queue 132. CPU 100 may comprise another instruction queue 133, referred to as the holding queue 133, which is not directly accessible by dispatching circuitry 120.

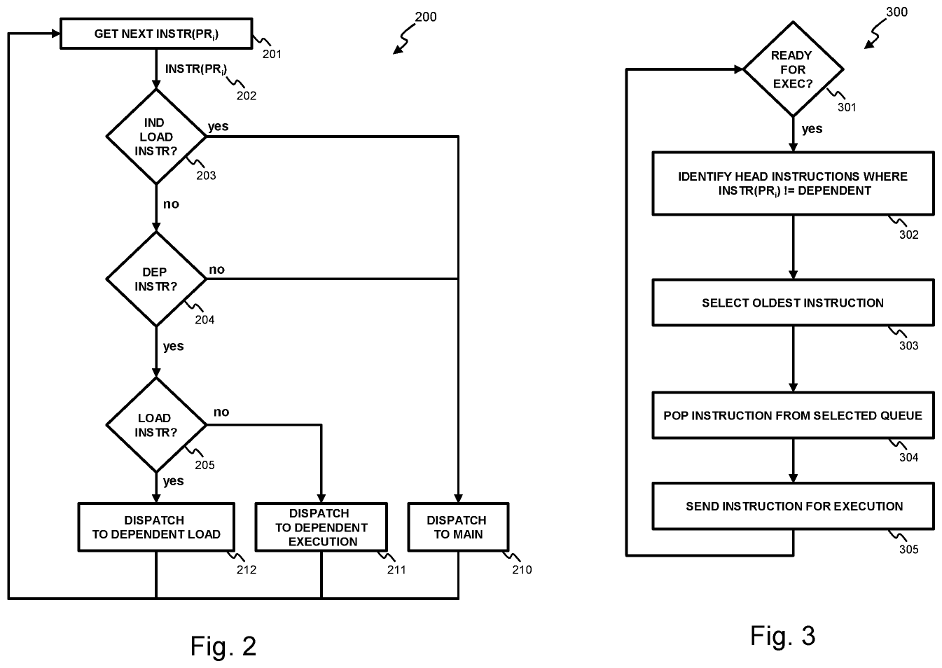

FIG. 2 illustrates steps 200 performed by dispatching circuitry 120. At the beginning, dispatching circuitry 120 fetches in a step 201 a next instruction 202 from the instructions 111. In step 203, it verifies whether the instruction is an independent load instruction or not. An independent load instruction is a load instruction that: i) upon execution, loads data from an addressable data memory 173 into one or more of the physical registers 160, and ii) does not depend on an instruction that is buffered in one of the instruction queues through one or more of its source physical registers. In other words, an independent load instruction is a load instruction that is independent from other instructions that are ahead but not yet executed within execution circuitry 150. When step 203 determines that instruction 202 is an independent load instruction, then the instruction is sent, i.e. dispatched, in step 210 to the main queue 130. When step 203 determines that instruction 202 is not an independent load instruction, then dispatching circuitry 120 proceeds to step 204. In this step 204, dispatching circuitry 120 checks whether instruction 202 is a dependent instruction, i.e. whether instruction 202 depends directly or indirectly on a previously dispatched independent load instruction. In other words, dispatching circuitry 120 checks whether instruction 202 directly or indirectly depends on a physical register value that will be written by such an independent load instruction. If instruction 202 is not such a dependent instruction, then the dispatching circuitry dispatches the instruction to the main queue 130 according to step 210. If instruction 202 is a dependent instruction, then the dispatching circuitry proceeds to step 205 where it is verified whether the dependent instruction is a load instruction or another type of instruction. When the instruction 202 is a load instruction, i.e. a so-called dependent load instruction, then it is dispatched to the dependent load queue 131 according to step 212. In the other case, the instruction 202 is dispatched to the dependent execution queue 132 in step 211. Upon dispatching the instruction 202 to one of the instruction queues, the dispatching circuitry 120 returns to step 201 and retrieves according to step 201 the next instruction for dispatching. In the event that a queue is full and the dispatching circuitry 120 has a next instruction ready to dispatch to that queue, then the dispatching 212, 211, 210 is stalled until the queue is freed by the execution of an instruction in that queue. Upon freeing, the instruction is dispatched onto the respective queue and the dispatching circuitry 120 resumes by fetching a next instruction according to step 201.

Instruction queues 130-133 are configured to buffer instructions that were previously dispatched as illustrated by arrows 121 to 123. A selection circuitry 140 is then configured to select an instruction from an instruction queue 130-133 as illustrated by arrows 134-137.

FIG. 3 illustrates steps performed by selection circuitry 140 according to an example embodiment. In a first step 301, selection circuitry 140 waits until a next instruction can be issued for execution circuitry 150. If so, circuitry 140 proceeds to the next step 302 where one or more of the queues 130-133 are identified that have an instruction at the head of the respective queue that is not a dependent instruction, i.e. the instruction does not reference a physical register of which the value still depends on another instruction in one of the instruction queues. If more than one queue and thus more than one instruction is available, then selection circuitry 140 selects in the next step 303 therefrom an instruction according to a certain selection policy. For example, selection circuitry 140 may select the oldest instruction, i.e. the instruction that was first dispatched onto the instruction queues. Other selection policies may be applied, e.g. a round-robin selection order or by assigning priorities to some of the instruction queues. Selection circuitry 140 may also select multiple instructions per cycle depending on the capabilities of execution circuitry 150, the amount and type of functional units on which the instructions are executed. In the next step 304, the selection circuitry 140 takes the selected instruction from the head of the selected queue and sends the instruction to the execution circuitry 150 for execution. The circuitry then returns to step 301 where it waits until a next instruction can be fetched from the instruction queues 130-133 for execution.

CPU 100 may further comprise holding queue 133 and a redirecting circuitry 138 for redirecting 139 instructions from the dependent execute queue 132 to the holding queue 133. Redirecting circuitry 138 redirects an instruction from the head of the dependent execute queue 132 when it has not been executed for a certain time, i.e. within a certain time threshold. This way, the dependent execute queue 132 is freed to serve other queued instructions that may be executed faster. An instruction that doesn't execute for a longer time in queue 132 may be caused by a load instruction residing in the dependent load queue 131 or main queue 130 that encountered a memory cache miss. Such a cache miss occurs when instruction accesses memory 173 and the instruction cannot be served by an intermediate caching memory. As an example, the CPU 100 according to FIG. 1 shows a two-level cache, i.e. having an L1 cache 171 and an L2 cache 172. The same principles may also apply to a CPU having any amount of caching levels. To anticipate for this, the redirecting circuitry 138 may be configured with a time threshold that anticipates for such a cache miss, e.g. by setting the time threshold to the time for successfully accessing the L1 or L2 memory cache 171, 172. Redirecting circuitry 138 may have a down counter configured to count the number of cycles for accessing one of the caches 171, 172. The down counter is then started when an instruction arrives at the head of the dependent execute queue 132 and is decremented after every cycle. When the down counter reaches zero, the configured cache miss has occurred. The instruction is then redirected to the holding queue 133. When the instruction is executed before the down counter reaches zero, then the down counter is reset. Such a counter is a hardware-efficient implementation as it allows determining a cache miss locally within the processor core at low overhead. Redirecting circuitry 138 may further be configured to redirect multiple consecutive instructions from the same queue at once to the holding queue when these instructions are dependent on the head instruction.

The redirecting may also be performed, before the instruction is at the head of the dependent execute queue or the downcounter equals zero. The redirecting may then be performed directly when an independent load is a cache miss. Upon this miss, the dependent instructions are then proactively redirected from the dependent queue to the holding queue.

The redirecting may also be performed for load instructions that reside in the dependent load queue 131. This may enable other loads in the dependent load queue 131 to execute faster. In such case, CPU 100 may comprise two holding queues, one for redirecting instructions from the dependent execute queue 131 and one for redirecting instructions from the dependent load queue 132.

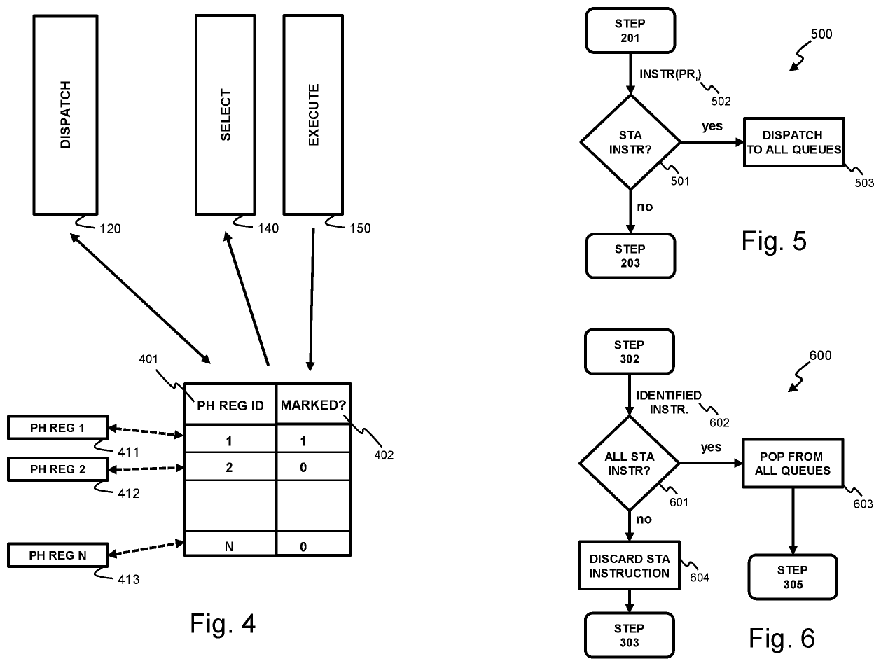

FIG. 4 illustrates a further embodiment of the CPU 100 of FIG. 1 wherein an additional field 402 is associated with each of the physical registers 411-413, e.g. by associating identifications 401 of the physical registers with such an additional field 402. The field 402 may then be used by the dispatching circuitry 120, selection circuitry 140 and execution circuitry 150 for configuring and determining the forward dependencies between the instructions. Field 402 allows to either mark or unmark the respective physical registers 411-413, e.g. by assigning it with a respective bit value of zero or one. When dispatching circuitry 120 receives a load instruction with unmarked source physical registers, i.e. having a value of zero in field 402, then the load instruction is considered an independent load instruction under step 203. Upon dispatching the independent load instruction to the main queue under step 210, one or more of the destination physical registers are marked. In case there are multiple destination physical registers, preferably all registers are marked. When dispatching circuitry 120 receives an instruction under step 204 that reads from at least one marked physical register, then the instruction is a dependent instruction. Further, one or more and preferably all destination physical registers of this same instruction are also marked before dispatching it onto the dependent load or execution queues 212, 211. By this marking scheme, the sequence of instructions that depend directly or indirectly on a load instruction is identified and will propagate forward into the different instruction queues 130-133.

Upon execution of an instruction by execution circuitry 150 and thus the computation of the instruction's physical destination register, the one or more physical destination registers are unmarked, e.g. by the execution circuitry 150. Alternatively, the unmarking may also be performed upon selection, e.g. by the selection circuitry 140. By unmarking a physical register, a future load instruction reading from the same physical register will then be considered independent and will be dispatched into the first queue 130.

FIGS. 5 and 6 illustrate further steps 500 and 600 that may be performed by respectively the dispatching circuitry 120 and selection circuitry 140. According to the embodiment of FIG. 5, a further verification step 501 is introduced between steps 201 and 203. In this step 501, the dispatching circuitry 120 verifies whether the instruction 502 received from step 201 is a store-address, STA, instruction, i.e. an instruction that computes the address in the addressable memory 173. If so, then the dispatching circuitry 120 dispatches the instruction to all queues 130-132 in accordance with step 503. In other words, the store-address instruction is replicated onto all queues. If not, then the dispatching circuitry 120 proceeds to the next step 203. When the STA instruction is dispatched, it will move along the instruction queues 130-132. Thereupon, selection circuitry 140 handles the STA instruction in a particular manner as illustrated by the steps 600 of FIG. 6 which may be introduced after step 302 of FIG. 3. In step 601, selection circuitry 140 checks first whether all identified instructions are the same STA instruction and whether they are present at the head of each queue 130-132. If so, the STA instruction may be executed and the selection circuitry 140 proceeds to step 603 where all STA instructions are popped from the head of each instruction queue and a single instance of the STA instruction is sent to step 305 for execution. In the other case, selection circuitry proceeds to step 604 wherein the STA instruction is removed from the identified instructions, i.e. not considered for execution, and then proceeds to step 303.

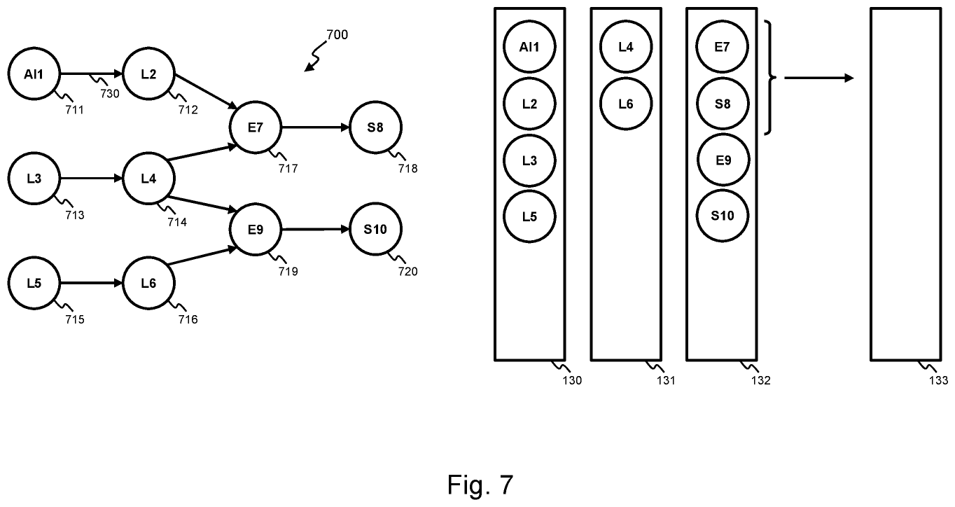

FIG. 7 illustrates an example of how a program code 700 with instructions 711 to 720 are dispatched onto instruction queues 130-133 and propagate further towards the selection circuitry 140. The code 700 includes an arithmetic instruction 711 (AI1), five load instructions 712, 713, 714, 715, 716 (L2 to L6), two arithmetic instructions 717, 719 (E7, E9) and two store instructions 718, 720 (S8, S10). Both the order of the reference signs 711-720 and the number of the instruction to which they refer reflect the order of the program code 700. The arrow 730 between the instructions 711-712 illustrates a data dependence. According to the steps 200 of FIG. 2, instruction AI1 is an independent instruction and load instructions L2, L3 and L5 are independent load instructions, hence all are dispatched to main queue 130. Load instructions L4 and L6 are dependent on respectively L3 and L5 and, hence, are dispatched to the dependent load queue 131. Arithmetic instructions E7 and E9 depend on load instructions L2, L4 and L6 and are thus dispatched to the dependent execute queue 132. Store instructions S8 and S10 on their turn depend on instructions E7 and E9 and, hence, are dispatched to the same dependent execute queue 132. When using a further holding queue 133 and using an L1-cache miss for the down counter then instructions may be redirected onto the holding queue 133. Assuming load instruction L2 encounters an L1-cache miss, then the down counter will trigger when E7 and S8 are at the head of the queue 132. In such case, instructions E7 and S8 will be redirected to the holding queue 133. Thereupon, instructions E9 and S10 may move forward in the queue 132 and execute before instructions E7 and S8.

According to an example embodiment, the instruction queues 130 to 133 may be in-order instruction queues, i.e. the order in which instructions enter a respective queue is also the order in which they are selected from the respective queue. In such case, the queue thus operates according to a first-in-first-out, FIFO, policy. Alternatively, one or more of the queues may allow out-of-order operation, i.e. a certain instruction in a respective queue may be moved forward such that it leaves the queue earlier and, hence, executes out-of-order with respect to the other instructions in the queue. In such case further circuitry may be foreseen to avoid breaking dependencies between instructions within a respective queue.

According to an example embodiment, holding queue 133 and redirecting circuitry 138 may also be used in other processor microarchitectures having other types of instruction queues than disclosed in this description. For example, holding queue 133 may be applied in any central processing unit, CPU comprising a plurality of physical registers and instruction queues respectively configured to buffer instructions for execution and wherein the instructions then reference one or more of the physical registers. In such case, the instruction queues comprise at least a first instruction queue and a second holding queue wherein the first queue is configured to redirect a head instruction from the head of the first instruction queue to the second holding queue when the head instruction has not been executed within a time threshold. Other features relating to the holding queue such as the counting circuitry as disclosed herein may then be further applied to any CPU that contains such a holding queue. Also, consecutive instructions depending on the head instructions may be redirected to the holding queue at once. The redirecting circuitry may further be configured to redirect multiple consecutive instructions from the same queue at once to the holding queue when these instructions are dependent on the head instruction. The redirecting may also be performed before the instruction is at the head of the dependent execute queue or the down counter equals zero. The redirecting may then be performed directly when an independent load is detected to be a cache miss. Upon this miss, the dependent instructions are then proactively redirected from the dependent queue to the holding queue. The redirecting may also be performed for load instructions that reside in the dependent load queue 131. This may enable other loads in the dependent load queue 131 to execute faster. In such case, CPU 100 may comprise two holding queues, one for redirecting instructions from the dependent execute queue 13 and one for redirecting instructions from the dependent load queue 13.

According to an example embodiment, the steps as illustrated in FIG. 5 and FIG. 6 may also be used in other processor microarchitectures having other types of instruction queues than disclosed in this description. This may be achieved by providing a central processing unit, CPU comprising a plurality of physical registers and instruction queues respectively configured to buffer instructions for execution and wherein the instructions then reference one or more of the physical registers. In such case, the CPU comprises a dispatching circuitry for dispatching the instructions to one or more of the instruction queues, and a selection circuitry for popping instructions from the instruction queues for further execution. The dispatching circuitry is then further configured to replicate an instruction onto all other instruction queues when the respective instruction is a store-address instruction for storing data within addressable memory. The selection circuitry is then further configured to only pop the store-address instruction from the queues when it is at the head of all the queues.

As used in this application, the term “circuitry” may refer to one or more or all of the following:
(a) hardware-only circuit implementations such as implementations in only analog and/or digital circuitry, and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus to perform various functions).

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware.

Although the present invention has been illustrated by reference to specific embodiments, it will be apparent to those skilled in the art that the invention is not limited to the details of the foregoing illustrative embodiments, and that the present invention may be embodied with various changes and modifications without departing from the scope thereof. The present embodiments are therefore to be considered in all respects as illustrative and not restrictive, the scope of the invention being indicated by the appended claims rather than by the foregoing description, and all changes which come within the scope of the claims are therefore intended to be embraced therein.

It will furthermore be understood by the reader of this patent application that the words “comprising” or “comprise” do not exclude other elements or steps, that the words “a” or “an” do not exclude a plurality, and that a single element, such as a computer system, a processor, or another integrated unit may fulfil the functions of several means recited in the claims. Any reference signs in the claims shall not be construed as limiting the respective claims concerned. The terms “first”, “second”, third”, “a”, “b”, “c”, and the like, when used in the description or in the claims are introduced to distinguish between similar elements or steps and are not necessarily describing a sequential or chronological order. Similarly, the terms “top”, “bottom”, “over”, “under”, and the like are introduced for descriptive purposes and not necessarily to denote relative positions. It is to be understood that the terms so used are interchangeable under appropriate circumstances and embodiments of the invention are capable of operating according to the present invention in other sequences, or in orientations different from the one(s) described or illustrated above.

1.-15. (canceled)

16. A central processing unit, CPU comprising a plurality of physical registers and instruction queues respectively configured to buffer instructions for execution; the instructions referencing one or more of the physical registers; the CPU further comprising a dispatching circuitry configured to:
when a respective instruction is an independent load instruction,
wherein the independent load instruction is a load instruction to load data from an addressable memory into a physical register, and is independent from instructions buffered in the instruction queues through the physical registers, then dispatch the respective instruction to a first queue of the instruction queues; and
when the respective instruction is a dependent instruction dependent on the independent load instruction through the physical registers, then dispatch the respective instruction to another queue of the instruction queues.

17. The CPU according to claim 16 wherein the dispatching circuitry is further configured to:
otherwise, dispatch the respective instruction to the first queue.

18. The CPU according to claim 16 wherein the dispatching circuitry is further configured to:
when the dependent instruction is a load instruction, then dispatch the dependent instruction to a second queue of the instruction queues; and
otherwise, dispatch the dependent instruction to a third queue of the instruction queues.

19. The CPU according to claim 18 wherein the instruction queues comprise a fourth queue; and
wherein the CPU comprises redirecting circuitry configured to redirect a head instruction from the head of the third queue to the fourth queue when the head instruction has not been executed within a time threshold.

20. The CPU according to claim 19 wherein the redirecting circuitry further comprises a counter configured to trigger the redirecting of the head instruction after a certain amount of clock cycles and to reset after the redirecting.

21. The CPU according to claim 19 wherein the time threshold corresponds to a time for accessing a memory cache.

22. The CPU according to claim 16 further comprising a selection circuitry configured to pop an instruction from one of the instruction queues for further execution.

23. The CPU according to claim 22 wherein the selection circuitry is further configured to perform the popping according to a selection policy.

24. The CPU according to claim 22 wherein the dispatching circuitry is further configured to:
when the respective instruction is a store-address instruction, and when the store-address instruction computes a target address in the addressable memory for later storage by a store-data instruction, then replicate the instruction onto all other instruction queues;
and wherein the selection circuitry is further configured to pop the store-address instruction from all the queues when it is at the head of all the queues.

25. The CPU according to claim 16 wherein the dispatching circuitry is further configured to stall when a queue targeted for dispatching is full.

26. The CPU according to claim 16 wherein the dispatching circuitry is further configured to:
when the respective instruction is an independent load instruction, mark at least one destination physical register referenced to by the independent load instruction,
when the respective instruction reads a marked physical register, then mark one or more destination physical registers of the respective instruction; and
wherein the CPU is configured to, when executing or selecting the respective instruction, unmark one or more of the marked physical registers.

27. The CPU according to claim 16 further comprising a register renaming circuitry configured to obtain instructions referencing one or more architectural registers, and to rename the referenced architectural registers to one or more of the physical registers.

28. The CPU according to claim 16 wherein the queues are in-order instruction queues.

29. The CPU according to claim 16 wherein one or more of the queues are out-of-order instruction queues.

30. A method comprising:
obtaining instructions for execution on a CPU; the instructions referencing one or more physical registers in the CPU;
dispatching a respective instruction to a first queue of instruction queues in the CPU when the respective instruction is an independent load instruction,
wherein the independent load instruction is a load instruction to load data from an addressable memory into a physical register, and is independent from instructions buffered in the instruction queues through the physical registers, and
wherein the instruction queues are respectively configured to buffer the instructions for execution;
dispatching the respective instruction to another queue of the instruction queues when the respective instruction is a dependent instruction depending on the independent load instruction through the physical registers.
